(19) United States
(12) Patent Application Publication
(10) Pub. No.: US 2004/0083040 A1
(43) Pub. Date: Apr. 29, 2004

(54) Vehicle data retrieval system

(76) Inventors: Thomas Parrott, Clarkston, MI (US); Mark Malinowski, Farmington Hills, MI (US); Robert Sibley, Howell, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/281,850

(22) Filed: Oct. 28, 2002

(51) Int. Cl. G06F 7/00

(52) U.S. Cl. 701/32; 235/435; 340/431

(57) ABSTRACT

A vehicle data retrieval system comprises a trailer and a data unit on the trailer. The data unit has access to vehicle information about the trailer and has a power input. A portable handheld computing device has a power output that powers the data unit through the power input and permits the retrieval of vehicle information from the data unit.

### BACKGROUND OF THE INVENTION

This invention relates to a system and method for retrieving vehicle information using a portable handheld computing device.

Tractor trailers have anti-lock braking systems that track vehicle information, such as trailer mileage, ABS status information, and vehicle identification number. During operation of the vehicle, this information could be provided to the tractor through a harness, known as a J560 trailer harness, from the trailer to the cabin of the tractor. This same harness further serves to power the braking system. When the trailer is detached from the tractor, the anti-lock braking system is not powered and, accordingly, is unable to provide information. For companies that maintain a fleet of trailers, a need exists to be able to secure information from parked or detached trailers for use in their service and maintenance quickly and conveniently.

Currently, to obtain information from the anti-lock braking system, the trailer is powered separately by a power source, such as a battery, through the trailer's harness. A technician then downloads this information from the ABS system's diagnostic connection through a lap top. Such a system thus requires an external power source and additional cable and communication interfaces that connect the lap top to the ABS system's diagnostic connection.

The diagnostic connection could be located under the trailer or with an additional harness away from the trailer's J560 harness. It is therefore difficult to gather information from these trailers in an efficient manner. Indeed the process is made more challenging when the information must be retrieved from a fleet of trailers.

A need therefore exists for a convenient data retrieval system that permits the quick collection of vehicle information from the trailer.

### SUMMARY OF THE INVENTION

The present invention is a system and method for vehicle data retrieval that permits the extraction of vehicle information from the trailer using existing vehicle connections. A trailer has an on-board data unit, such as an anti-lock brake system, which may store vehicle information about the trailer. The data unit has a power input for supplying power and activating the unit.

In contrast to existing systems, a portable handheld computing device has a power output in communication with the power input of the data unit, powering the data unit to permit the retrieval of vehicle information from the data unit. The portable handheld computing device may have a battery storing power for the data unit. A DC voltage may be supplied from the power output of the handheld to the power input of the data unit. A line between the portable handheld computing device and the data unit can serve as a power supply line. This same line may also serve to communicate data from the data unit to the portable handheld computing device. This line may be a J560 trailer harness.

Once the data unit is powered by the portable handheld computing device, the computing device retrieves vehicle information from the data unit and stores the data. The portable handheld computing device may further display the data on the unit and even convert the data from the ABS system's computer protocol to another computer protocol suitable for other computing systems. The first computer protocol may be a PLC format while the second computer protocol may comprise a 1587 format. In this way, vehicle information, such as trailer mileage information, ABS fault status information, or vehicle identification information, may be retrieved from the data unit of the anti-lock braking system.

The portable handheld computing device has a housing with a display. A processor communicates with a display to control its output. The portable handheld device also has a battery within the housing storing a predetermined amount of power sufficient to activate the data unit holding the vehicle information on a trailer and to permit the processor to access the vehicle information from the data unit. The power may comprise a direct current voltage of, say 12 volts.

Accordingly, power is supplied from a battery of a portable handheld computing device to a data unit on a trailer. The data unit is activated and vehicle data on the trailer is retrieved by the computing device. The vehicle information is then stored and displayed and may be later downloaded to a computer.

The system and method permits the powering and retrieval of the data unit of the ABS system through a single line. A technician need only make a single connection at one point of the trailer rather than make two connections at two different locations. Moreover, the handheld unit is much cheaper to produce than a laptop.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 illustrates a side view of trailer, data unit and portable handheld computing device.

FIG. 2 illustrates a view of the portable handheld computing device of FIG. 1.

FIG. 3 illustrates the inventive method.

### DETAILED DESCRIPTION OF THE PREFERRED EMBODIMENT

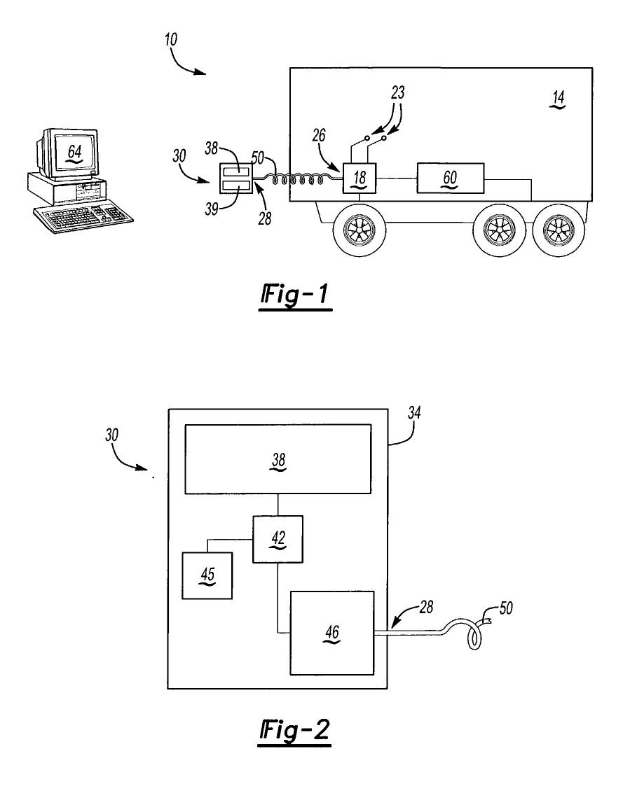

FIG. 1 illustrates the inventive vehicle data retrieval system 10. Shown are trailer 14 having an onboard data unit 18, which may comprise a portion of anti-lock braking system 60. Data unit 18 may store vehicle information, such as trailer mileage, ABS status information, and vehicle identification information. Line 50, say a J560 trailer harness, is connected to the onboard computer of the tractor, not shown. As known, line 50 both powers data unit 18 and permits the transmission of vehicle information from data unit 18 to the onboard computer of the tractor.

Without a tractor, data unit 18 has no independent source of power and is deactivated. Accordingly, information to which data unit has access is unavailable. Such information may be available by powering data unit 18 through line 50 and then obtaining the vehicle information through ABS system diagnostic connection 23, which is typically located under or with an optional cable on the side of the trailer, away from line 50.

As shown in FIG. 1, the inventive vehicle data retrieval system 10 connects portable handheld computing device 30 through line 50 to data unit 18. Portable handheld computing device 30 has display 38 and input device 39, such as a keypad, which is in communication with processor 42 (see FIG. 2) to control portable handheld computing device 30.

As shown in FIG. 2, portable handheld computing device has within housing 34 processor 42 to provide control over display 38 and interface with input device 39 (shown in FIG. 1). In addition, within housing 34 is battery 46. Battery 46 has sufficient capacity to provide power to processor 42 and display 38. In addition, in contrast to existing handheld computing devices, battery 46 has sufficient power to power data unit 18 of trailer 14. Data unit 18 is thus powered by battery 46 of portable handheld computing device 30 through line 50, a J560 trailer harness. Line 50 is more accessible than anti-lock braking system diagnostic connections 23. Moreover, a single unit permits both the powering of data unit 18 and the retrieval of vehicle information stored within data unit 18. Such vehicle information may comprise trailer mileage information, ABS fault status information, vehicle identification information, tire pressure, brake wear, actuator stroke, axle temperature or other information that may be stored by any computing unit on trailer 14.

Once portable handheld computing device 30 powers data unit 18 through line 50, data unit 18 is activated and retrieves vehicle information. This vehicle information is then passed to portable handheld computing device 30 through line 50. As known, such information may be communicated on an electrical signal that rides a carrier signal, such as a power line carrier signal.

Line 50 then communicates vehicle information to processor 42 for display on display 38 or storage on the storage device 45. Housing 34 has power output 28 which has connections compatible with line 50, which itself connects to power input 26 of data unit 18 as known.

Processor 42 of portable handheld computing device 30 may further convert data received through line 50 from data unit 18 from a first computer protocol to a second computer protocol. The first computer protocol may be a PLC format as used with an anti-lock braking system 60 while the second computer protocol may comprise a 1587 format.

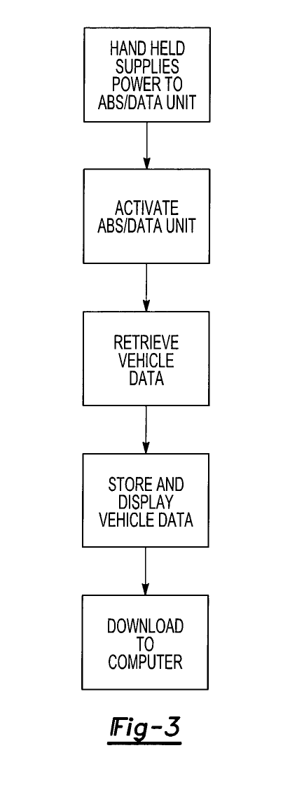

Portable handheld computing device 30 has sufficient power to activate data unit 18. Power supplied from portable handheld computing device may be a direct current voltage, say 12 volts, commonly used for ABS system 60 and data unit 18. Once data unit 18 receives power, data unit 18 is activated to retrieve vehicle data concerning the status of trailer 14. Portable handheld computing device 30 may retrieve vehicle information and store it for later downloading on computer 64. These steps are summarized on FIG. 3.

In this way, the inventive system and method permits the quick and convenient retrieval of vehicle information from data unit 18. The existing J560 trailer harness may be employed to avoid having to retrieve information through the ABS system diagnostic connections 23 as well as the separate powering of the data unit 18 through another line. A technician may then download information from a fleet of trailers, moving from one trailer to another to collect information about a particular trailer for immediate display or later storage on computer 64. The technician may move from trailer harness to trailer harness without having to make separate connections for powering and retrieving information from data unit as done in the past. Only the amount of charge within battery 46 limits the number of the trailers the technician may retrieve such information.

The aforementioned description is exemplary rather that limiting. Many modifications and variations of the present invention are possible in light of the above teachings. The preferred embodiments of this invention have been disclosed. However, one of ordinary skill in the art would recognize that certain modifications would come within the scope of this invention. Hence, within the scope of the appended claims, the invention may be practiced otherwise than as specifically described. For this reason the following claims should be studied to determine the true scope and content of this invention.

What is claimed is:

1. A vehicle data retrieval system, comprising:
a trailer;
a data unit on said trailer, accessing vehicle information about said trailer and having a power input; and
a portable handheld computing device having a power output in communication with said power input, powering said data unit and retrieving said vehicle information from said data unit.

2. The vehicle data retrieval system of claim 1 wherein said portable handheld computing device includes a battery storing power for said power output.

3. The vehicle data retrieval system of claim 1 wherein said power output supplies a dc voltage to said power input.

4. The vehicle data retrieval system of claim 1 including a line between said portable handheld computing device and said data unit, communicating power from said power output to said power input.

5. The vehicle data retrieval system of claim 4 wherein said line further communicates data between said portable handheld computing device and said data unit.

6. The vehicle data retrieval system of claim 1 wherein said portable handheld computing device stores data from said data unit.

7. The vehicle data retrieval system of claim 1 wherein said portable handheld computing device displays data from said data unit.

8. The vehicle data retrieval system of claim 1 wherein said portable handheld computing device converts data from said data unit from a first computer protocol to a second computer protocol.

9. The vehicle data retrieval system of claim 9 wherein said first computer protocol comprises PLC format and said second computer protocol comprises 1587 format.

10. The vehicle data retrieval system of claim 1 wherein said vehicle information comprises at least one of trailer mileage information, fault status information, or vehicle identification information.

11. The vehicle data retrieval system of claim 1 wherein said data unit comprises a portion of an anti-lock braking system.

12. A portable handheld computing device, comprising:
a housing having a display;
a processor within said housing in communication with said display; and
a battery within said housing, storing a predetermined amount of power sufficient to activate a data unit holding vehicle information on a trailer and to permit said processor to access the vehicle information from the data unit.

13. The portable handheld computing device of claim 12 wherein said power comprises a direct current voltage.

14. The portable handheld computing device of claim 13 wherein said direct current voltage is 12 volts.

15. The portable handheld computing device of claim 12 including a power supply link.

16. The portable handheld computing device of claim 15 wherein said power supply link serves as a data link to provide said processor with the vehicle information.

17. The portable handheld computing device of claim 16 wherein said power supply link comprises a J560 trailer harness.

18. A method of vehicle data retrieval comprising the steps of:
a) supplying power from a battery of a portable handheld computing device to a data unit on a trailer;
b) activating the data unit to retrieve vehicle data concerning a status of the trailer;
c) retrieving the vehicle information through the portable handheld computing device; and
d) storing the vehicle information on the portable handheld computing device.

19. The method of claim 18 including the step of e) downloading the vehicle data to a computer.

20. The method of claim 18 including the step of f) converting the vehicle data from a first computer format to a second computer format.
